(19) United States
(12) Patent Application Publication
(10) Pub. No.: US 2013/0342154 A1
(43) Pub. Date: Dec. 26, 2013

(54) CHARGING APPARATUS

(71) Applicant: DENSO CORPORATION, Kariya-city (JP)

(72) Inventor: Kenji YAMAMOTO, Nagoya-city (JP)

(21) Appl. No.: 13/918,406

(22) Filed: Jun. 14, 2013

(30) Foreign Application Priority Data
Jun. 22, 2012 (JP) 2012-140794

(51) Int. Cl. H02J 7/00

(52) U.S. Cl. CPC H02J 7/007; H02J 7/0052
USPC 320/101; 320/107

(57) ABSTRACT

A charging apparatus includes a power generation device, a first charging circuit, a second charging circuit, and a control circuit. The first charging circuit has an input terminal coupled to the power generation device and an output terminal coupled to a low-voltage battery. The first charging circuit increases or reduces an output voltage of the power generation device and charges the low-voltage battery. The second charging circuit has an input terminal and an output terminal coupled to a high-voltage battery having a voltage higher than the low-voltage battery. The second charging circuit increases a voltage inputted from the input terminal of the second charging circuit and charges the high-voltage battery. The control circuit couples the input terminal of the second charging circuit to one of the power generation device and the low-voltage battery, and controls the first charging circuit and the second charging circuit.

### CROSS REFERENCE TO RELATED APPLICATION

This application is based on Japanese Patent Application No. 2012-140794 filed on Jun. 22, 2012, the disclosure of which is incorporated herein by reference.

### TECHNICAL FIELD

The present disclosure relates to a charging apparatus including a first charging circuit and a second charging circuit and charging a low-voltage battery and a high-voltage battery.

### BACKGROUND

As an example of a charging apparatus that includes a first charging circuit and a second charging circuit and charges a low-voltage battery and a high-voltage battery, JP2012-075241A discloses a control apparatus for an electronic vehicle.

The control apparatus includes a non-contact charging device, a first DC to DC converter, and a second DC to DC converter. An input terminal of the first DC to DC converter is coupled to the non-contact charging device, and an output terminal of the first DC to DC converter is coupled to a high-voltage main battery. An input terminal of the second DC to DC converter is coupled to the non-contact charging device, and an output terminal of the second DC to DC converter is coupled to a low-voltage sub battery, which has a voltage lower than the high-voltage main battery.

Also, JP2012-075241A describes that the non-contact charging device may be a solar panel. When the non-contact charging device is the solar panel, the first DC to DC converter increases a voltage outputted from the solar panel and the high-voltage main battery is charged with the voltage increased by the first DC to DC converter. Also, the second DC to DC converter reduces the voltage outputted from the solar panel, and the low-voltage battery is charged with the voltage reduced by the second DC to DC converter.

### SUMMARY

In fact, the output voltage of the solar panel is likely to be largely affected by a solar light. Therefore, the high-voltage main battery may be charged with a voltage outputted from the low-voltage sub battery. In such a case, a DC to DC converter is additionally required to increase the voltage outputted from the low-voltage sub battery. As a result, the structure of such an apparatus is likely to be complicated, and costs of the apparatus are likely to increase.

It is an object of the present disclosure to provide a charging apparatus having a simple structure and being capable of increasing a voltage outputted from a low-voltage battery and charging a high-voltage battery with the voltage increased.

According to an aspect of the present disclosure, a charging apparatus includes a power generation device, a first charging circuit, a second charging circuit and a control circuit. The first charging circuit has an input terminal coupled to the power generation device and an output terminal coupled to a low-voltage battery. The first charging circuit increases or reduces a voltage outputted from the power generation device, and the low-voltage battery is charged with the voltage increased or reduced by the first charging circuit. The second charging circuit has an input terminal and an output terminal. The output terminal of the second charging circuit is coupled to a high-voltage battery that has a voltage higher than the low-voltage battery. The second charging circuit increases a voltage inputted from the input terminal of the second charging circuit, and the high-voltage battery is charged with the voltage increased by the second charging circuit. The control circuit couples the input terminal of the second charging circuit to one of the power generation device and the low-voltage battery, and controls the first charging circuit and the second charging circuit.

In the charging apparatus, the input terminal of the second charging circuit is coupled to the low-voltage battery. Therefore, the voltage outputted from the low-voltage battery is increased by the second charging circuit, and the high-voltage battery is charged with the voltage increased by the second charging circuit. Accordingly, the high-voltage battery is charged with the voltage that is outputted from the low-voltage battery and increased, without complicating a structure of the charging apparatus.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which: FIG. 1 is a circuit diagram of a charging apparatus according to an embodiment of the present disclosure;

FIG. 2 is a flowchart illustrating an operation of the charging apparatus shown in FIG. 1; and

FIG. 3 is a diagram illustrating operation states of the charging apparatus shown in FIG. 1.

### DETAILED DESCRIPTION

An embodiment of the present disclosure will be described with reference to FIGS. 1 to 3. In the embodiment, for example, a charging apparatus is mounted in a vehicle and used for charging a main battery and an auxiliary battery.

First, a structure of a charging apparatus 1 will be described with reference to FIG. 1. The charging apparatus 1 increases or decreases a voltage of electric power generated from a solar light, and charges a main battery (high-voltage battery) BH and an auxiliary battery (low-voltage battery) BL with the increased or decreased voltage. Also, the charging apparatus 1 increases a voltage outputted from the auxiliary battery BL and charges the main battery BH with the increased voltage. Further, the charging apparatus 1 reduces a voltage outputted from the main battery BH and charges the auxiliary battery BL with the reduced voltage after the vehicle begins its operation.

The auxiliary battery BL serves as a power source that can charge or discharge electric power and supply the electric power to auxiliary devices, which are mounted in the vehicle, and the charging apparatus 1. The main battery BH serves as a power source that can charge or discharge electric power, and supply the electric power to a power control unit PCU for driving a vehicle traveling motor. The voltage of the main battery BH is higher than the voltage of the auxiliary battery BL.

A positive terminal of the main battery BH is coupled to a positive input terminal of the power control unit PCU through a switch SMR1. A negative terminal of the main battery BH is coupled to a negative input terminal of the power control unit CPU through a switch SMR2.

The charging apparatus 1 includes a solar panel 10, a voltage-reducing converter 11, a voltage-increasing converter 12, a voltage-reducing converter 13, and a control circuit 14. The solar panel 10 is an example of a power generation device or a solar power generation device. The voltage-reducing converter 11 serves as a first charging circuit, and the voltage-increasing converter 12 serves as a second charging circuit.

The solar panel 10 is a device that generates electric power from a solar light. The solar panel 10 outputs a voltage that is higher than the voltage of the auxiliary battery BL and is lower than the voltage of the main battery BH.

A positive output terminal of the solar panel 10 is coupled to the voltage-reducing converter 11, a switch 140, a comparator 147, a comparator 148, and a controller 149. A negative output terminal of the solar panel 10 is coupled to the voltage-reducing converter 11 and a switch 141.

The voltage-reducing converter 11 begins its operation when being supplied with a voltage. The voltage-reducing converter 11 is a circuit that reduces the voltage outputted from the solar panel 10 and charges the auxiliary battery BL with the reduced voltage.

A positive input terminal of the voltage-reducing converter 11 is coupled to the positive output terminal of the solar panel 10. A negative input terminal of the voltage-reducing converter 11 is coupled to the negative output terminal of the solar panel 10. A positive output terminal of the voltage-reducing converter 11 is coupled to a positive terminal of the auxiliary battery BL. A negative output terminal of the voltage-reducing converter 11 is coupled to a negative terminal of the auxiliary battery BL. Further, a power supply terminal of the voltage-reducing converter 11 is coupled to a switch 145.

The voltage-increasing converter 12 begins its operation when being supplied with a voltage. The voltage-increasing converter 12 is a circuit that increases a voltage inputted from an input terminal and charges the main battery BH with the increased voltage.

When the voltage-increasing converter 12 is coupled to the solar panel 10 through the switches 140, 141, the voltage-increasing converter 12 increases the voltage outputted from the solar panel 10 and charges the main battery BH, which is coupled to the voltage-increasing converter 12 through the switches 142, 143, with the increased voltage. When the voltage-increasing converter 12 is coupled to the auxiliary battery BL through the switches 140, 141, the voltage-increasing converter 12 increases the voltage outputted from the auxiliary battery BL and charges the main battery BH, which is coupled to the voltage-increasing converter 12 through the switches 142, 143, with the increased voltage.

A positive input terminal of the voltage-increasing converter 12 is coupled to the switch 140. A negative input terminal of the voltage-increasing converter 12 is coupled to the switch 141. A positive output terminal of the voltage-increasing converter 12 is coupled to the switch 142. A negative output terminal of the voltage-increasing converter 12 is coupled to the switch 143. A power supply terminal of the voltage-increasing converter 12 is coupled to switches 144, 146.

The voltage-reducing converter 13 is a circuit that reduces an output voltage of the main battery BH and charges the auxiliary battery BL with the reduced voltage after the vehicle begins its operation. The voltage-reducing converter 13 is coupled to the main battery BH through the switch SMR1 and the switch SMR2. The voltage-reducing converter 13 reduces the output voltage of the main battery BH and charges the auxiliary battery BL with the reduced voltage.

A positive input terminal of the voltage-reducing converter 13 is coupled to the switch SMR1. A negative input terminal of the voltage-reducing converter 13 is coupled to the switch SMR2. A positive output terminal of the voltage-reducing converter 13 is coupled to the positive terminal of the auxiliary battery BL. A negative output terminal of the voltage-reducing converter 13 is coupled to the negative terminal of the auxiliary battery BL.

The control circuit 14 couples the positive and negative input terminals of the voltage-increasing converter 12 to the solar panel 10 or the auxiliary battery BL, and couples the positive and negative output terminals of the voltage-increasing converter 12 to the main battery BH. Also, the control circuit 14 controls the voltage-reducing converter 11 and the voltage-increasing converter 12. The control circuit 14 includes the switches 140 to 146, the comparators 147, 148 and the controller 149.

The switches 140, 141 are controlled by the controller 149. The switch 140 is an element that couples the positive input terminal of the voltage-increasing converter 12 to the positive output terminal of the solar panel 10 or the positive terminal of the auxiliary battery BL. The switch 141 is an element that couples the negative input terminal of the voltage-increasing converter 12 to the negative output terminal of the solar panel 10 or the negative terminal of the auxiliary battery BL.

The switch 140 has a common terminal coupled to the positive input terminal of the voltage-increasing converter 12. Also, the switch 140 has a terminal coupled to the positive output terminal of the solar panel 10, and a terminal coupled to the positive terminal of the auxiliary battery BL. Further, the switch 140 has a control terminal coupled to the controller 149.

The switch 141 has a common terminal coupled to the negative input terminal of the voltage-increasing converter 12. Also, the switch 141 has a terminal coupled to the negative output terminal of the solar panel 10, and a terminal coupled to the negative terminal of the auxiliary battery BL. Further, the switch 141 has a control terminal coupled to the controller 149.

The switches 142, 143 are controlled by the controller 149. The switch 142 is an element that couples the positive output terminal of the voltage-increasing converter 12 to the positive terminal of the main battery BH. The switch 143 is an element that couples the negative output terminal of the voltage-increasing converter 12 to the negative terminal of the main battery BH.

The switch 142 has a terminal that is coupled to the positive output terminal of the voltage-increasing converter 12 and a terminal that is coupled to the positive terminal of the main battery BH. Further, the switch 142 has a control terminal that is coupled to the controller 149.

The switch 143 has a terminal that is coupled to the negative output terminal of the voltage-increasing converter 12 and a terminal that is coupled to the negative terminal of the main battery BH. Further, the switch 143 has a control terminal that is coupled to the controller 149.

The switch 144 is controlled by the comparator 147. The switch 144 is an element that couples the power supply terminal of the voltage-increasing converter 12 to the positive terminal of the auxiliary battery BL so as to supply the voltage to the voltage-increasing converter 12 for operating the voltage-increasing converter 12.

The switch 144 has a terminal coupled to the power supply terminal of the voltage-increasing converter 12, and a terminal coupled to the positive terminal of the auxiliary battery BL. Also, the switch 144 has a control terminal coupled to the comparator 147.

The switch 145 is controlled by the comparator 148. The switch 145 is an element that couples the power supply terminal of the voltage-reducing converter 11 to the auxiliary battery BL so as to supply the voltage to the voltage-reducing converter 11 for operating the voltage-reducing converter 11.

The switch 145 has a terminal coupled to the power supply terminal of the voltage-reducing converter 11, and a terminal coupled to the positive terminal of the auxiliary battery BL. Also, the switch 145 has a control terminal coupled to the comparator 148.

The switch 146 is controlled by the controller 149. The switch 146 is an element that couples the power supply terminal of the voltage-increasing converter 12 to the positive terminal of the auxiliary battery BL so as to supply the voltage to the voltage-increasing converter 12 and the voltage-reducing converter 13 for operating the voltage-increasing converter 12 and the voltage-reducing converter 13. The switch 145 has a terminal coupled to the power supply terminal of the voltage-increasing converter 12, and a terminal coupled to the positive terminal of the auxiliary battery BL. Also, the switch 145 has a control terminal coupled to the controller 149.

The comparator 147 turns on the switch 144 when an output power of the solar panel 10 is greater than a first reference power Pref_H. In particular, the comparator 147 turns on the switch 144 when the output voltage of the solar panel 10, which has a relationship with the output power of the solar panel 10, is greater than a first reference voltage Vref_H.

The first reference power Pref H is set to a value that is greater than power loss that is lost when the main battery BH is charged through the voltage-increasing converter 12. Further, the first reference power Pref H is set to a value so that a frequency of charging the main battery BH through the voltage-increasing converter 12 does not exceed a predetermined value in an assumed operation state.

An inverting input terminal of the comparator 147 is coupled to a reference power source (not shown) that is set to the first reference voltage Vref_H. A non-inverting input terminal of the comparator 147 is coupled to the positive output terminal of the solar panel 10. An output terminal of the comparator 147 is coupled to the control terminal of the switch 144. The comparator 148 is an element that turns on the switch 145 when the output power of the solar panel 10 is greater than a second reference power Pref_L that is lower than the first reference power Pref_H. In particular, the comparator 148 turns on the switch 145, when the output voltage of the solar panel 10 is greater than a second reference voltage Vref_L that is lower than the first reference voltage Vref_H.

The second reference power Pref L is set to a value that is greater than power loss that is lost when the auxiliary battery BL is charged through the voltage-reducing converter 11. Also, the second reference power Pref L is set to a value so that a frequency of charging the auxiliary battery BL through the voltage-reducing converter 11 does not exceed a predetermined value.

An inverting input terminal of the comparator 148 is coupled to a reference power source (not shown) set to the second reference voltage Vref_L. A non-inverting input terminal of the comparator 148 is coupled to the positive output terminal of the solar panel 10. An output terminal of the comparator 148 is coupled to the control terminal of the switch 145.

When the output power of the solar panel 10 is greater than the first reference power Pref H, the controller 149 controls the switches 140, 141 so that the switches 140, 141 couple the voltage-increasing converter 12 to the solar panel 10 and turns on the switches 142, 143. When the output power of the solar panel 10 is equal to or lower than the first reference power Pref_H and a remaining capacity of the auxiliary battery BL is at a dischargeable level, the controller 149 controls the switches 140, 141 so that the switches 140, 141 couple the voltage-increasing converter 12 to the auxiliary battery BL and turns on the switches 142, 143, 146.

In particular, when the output voltage of the solar panel 10 is greater than the first reference voltage Vref_H, the controller 149 controls the switches 140, 141 to be coupled to the solar panel 10 and turns on the switches 142, 143. When the output voltage of the solar panel 10 is equal to or lower than the first reference voltage Vref H and the remaining capacity of the auxiliary battery BL, which is calculated based on the output voltage of the solar panel 10, is at the dischargeable level, the controller 149 controls the switches 140, 141 to be coupled to the auxiliary battery BL and turns on the switches 142, 143, 146.

Here, the remaining capacity of the auxiliary battery BL being at the dischargeable level means that the remaining capacity of the auxiliary battery

BL is at a level between an upper limit and a lower limit. In other words, the dischargeable level is any level between the upper limit and the lower limit of the remaining capacity of the auxiliary battery BL. When the remaining capacity of the auxiliary battery BL is at the dischargeable level, the auxiliary battery BL is in a dischargeable state.

The controller 149 has an input terminal coupled to the positive output terminal of the solar panel 10 and an input terminal coupled to the positive terminal of the auxiliary battery BL. The controller 149 has output terminals coupled to the switches 140 to 143 and 146. The controller 149 has a power supply terminal coupled to the positive terminal of the auxiliary battery BL.

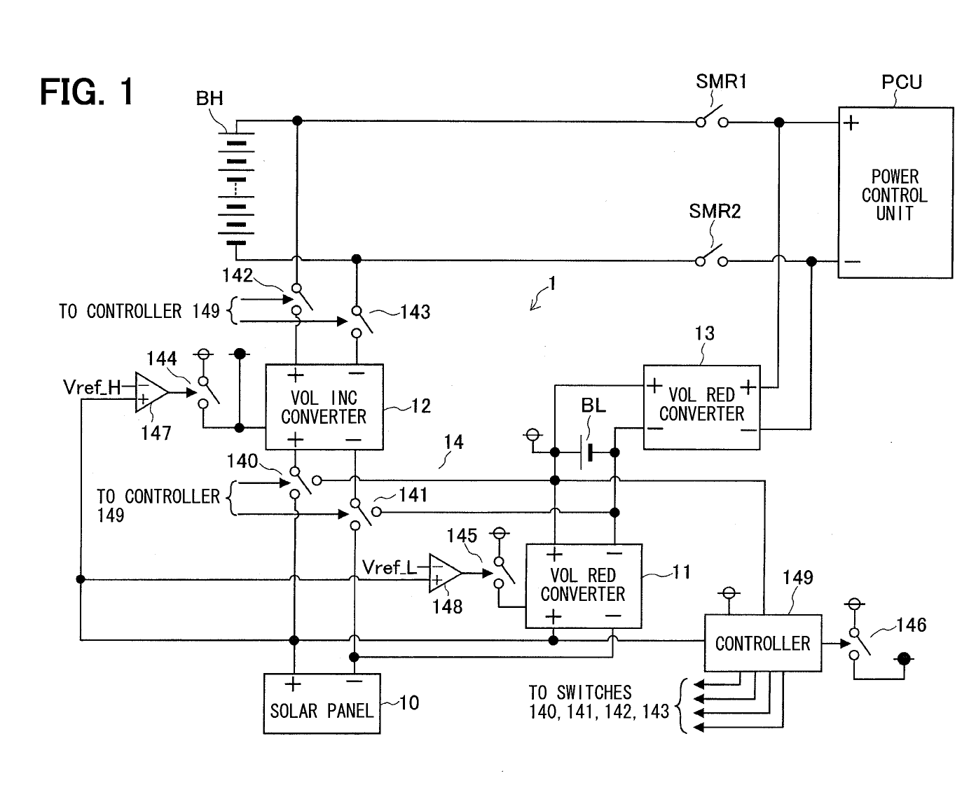

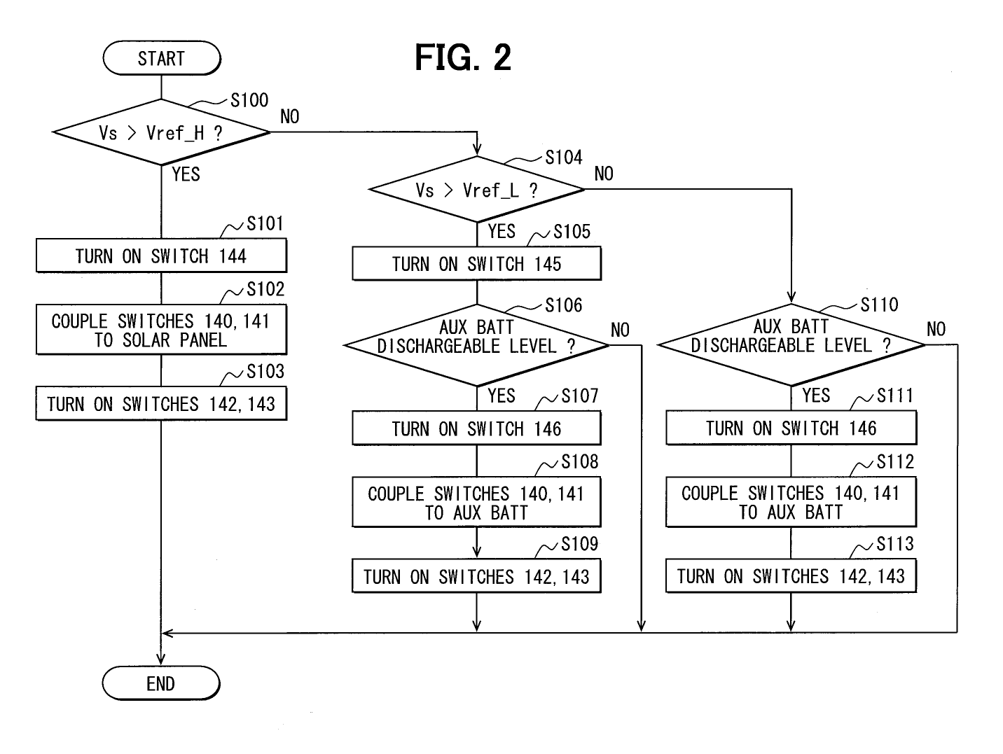

Next, an operation of the charging apparatus 1 will be described with reference to FIG. 2.

When a process shown in FIG. 2 is started, the switches 140, 141 are in a decoupled state. Also, the switches 142 to 146 are in an off state. Before the vehicle begins its operation, the charging apparatus 1 determines whether the output voltage of the solar panel 10 is greater than the first reference voltage Vref_H (S100).

When it is determined that the output voltage Vs of the solar panel 10 is greater than the first reference voltage Vref_H (S100 : YES), the comparator 147 turns on the switch 144 (S101). In this case, because the voltage is supplied from the auxiliary battery BL to the voltage-increasing converter 12, the voltage-increasing converter 12 begins its operation.

Further, the controller 149 controls the switches 140, 141 to be coupled to the solar panel 10 such that the positive input terminal and the negative input terminal of the voltage-increasing converter 12 are coupled to the positive output terminal and the negative output terminal of the solar panel 10, respectively (S102). The controller 149 turns on the switches 142, 143 such that the positive output terminal and the negative output terminal of the voltage-increasing converter 12 are coupled to the positive terminal and the negative terminal of the main battery BH, respectively (S103). Therefore, the output voltage of the solar panel 10 is increased by the voltage-increasing converter 12, and the main battery BH is charged with the increased voltage.

When it is determined that the output voltage Vs of the solar panel 10 is equal to or lower than the first reference voltage Vref H (S101: NO), the charging apparatus 1 determines whether the output voltage Vs of the solar panel 10 is greater than the second reference voltage Vref_L (S104).

When it is determined that the output voltage Vs of the solar panel 10 is greater than the second reference voltage Vref_L (S104: YES), the comparator 148 turns on the switch 145 (S105). In this case, because the voltage is supplied from the auxiliary battery BL to the voltage-reducing converter 11, the voltage-reducing converter 11 begins its operation. As a result, the output voltage Vs of the solar panel 10 is reduced by the voltage-reducing converter 11, and the auxiliary battery BL is charged with the reduced voltage.

Then, it is determined whether the remaining capacity of the auxiliary battery BL is at the dischargeable level (S106).

When it is determined that the remaining capacity of the auxiliary battery BL is at the dischargeable level (S106: YES), the controller 149 turns on the switch 146 (S107). In this case, because the voltage is supplied from the auxiliary battery BL to the voltage-increasing converter 12, the voltage-increasing converter 12 begins its operation. The controller 149 controls the switches 140, 141 to be coupled to the auxiliary battery BL such that the positive input terminal and the negative input terminal of the voltage-increasing converter 12 are coupled to the positive terminal and the negative terminal of the auxiliary battery BL, respectively (S108).

The controller 149 turns on the switches 142, 143 such that the positive output terminal and the negative output terminal of the voltage-increasing converter 12 are coupled to the positive terminal and the negative terminal of the main battery BH, respectively (S109). Therefore, the output voltage of the auxiliary battery BL is increased by the voltage-increasing converter 12, and the main battery BH is charged with the increased voltage.

When it is determined that the remaining capacity of the auxiliary battery BL is not at the dischargeable level (S106: NO), the state immediately before S106 is maintained.

When it is determined that the output voltage Vs of the solar panel 10 is equal to or lower than the second reference voltage Vref_L (S104: NO), the charging apparatus 1 determines whether the remaining capacity of the auxiliary battery BL is at the dischargeable level (S110).

When it is determined that the remaining capacity of the auxiliary battery BL is at the dischargeable level (S110: YES), the controller 149 turns on the switch 146 (S111). In this case, because the voltage is supplied from the auxiliary battery BL to the voltage-increasing converter 12, the voltage-increasing converter 12 begins its operation.

The controller 149 controls the switches 140, 141 to be coupled to the auxiliary battery BL such that the positive input terminal and the negative input terminal of the voltage-increasing converter 12 are coupled to the positive terminal and the negative terminal of the auxiliary battery BL, respectively (S112). Further, the controller 149 turns on the switches 142, 143 such that the positive output terminal and the negative output terminal of the voltage-increasing converter 12 are coupled to the positive terminal and the negative terminal of the main battery BH, respectively (S113). Therefore, the output voltage of the auxiliary battery BL is increased by the voltage-increasing converter 12, and the main battery BH is charged with the increased voltage.

When it is determined that the remaining capacity of the auxiliary battery BL is not at the dischargeable level (S110: NO), the state immediately before S110 is maintained.

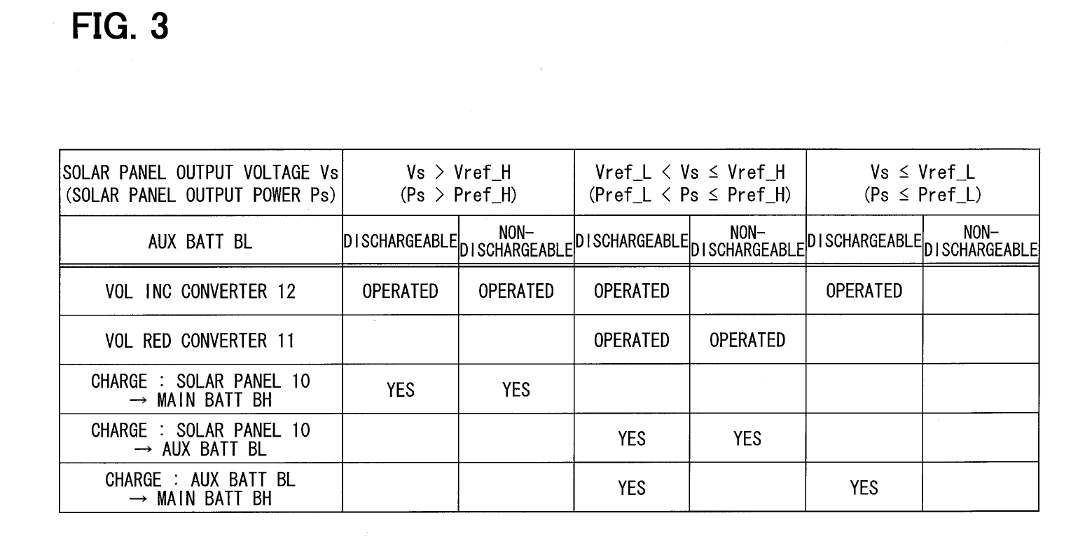

As shown in FIG. 3, when the output voltage Vs of the solar panel 10 is greater than the first reference voltage Vref_H, that is, the output power Ps of the solar panel 10 is greater than the first reference power Pref_H, the charging apparatus 1 operates the voltage-increasing converter 12 to increase the output voltage Vs of the solar panel 10 and charges the main battery BH with the increased voltage.

When the output voltage Vs of the solar panel 10 is equal to or lower than the first reference voltage Vref_H and greater than the second reference voltage Vref_L, that is, the output power Ps of the solar panel 10 is equal to or lower than the first reference power Pref_H and greater than the second reference power Pref_L, the charging apparatus 1 operates the voltage-reducing converter 11 to reduce the output voltage Vs of the solar panel 10 and charges the auxiliary battery BL with the reduced voltage.

When the output voltage Vs of the solar panel 10 is equal to or lower than the first reference voltage Vref_H and the remaining capacity of the auxiliary battery BL is at the dischargeable level, that is, when the output power Ps of the solar panel 10 is equal to or lower than the first reference power Pref_H and the remaining capacity of the auxiliary battery BL is at the dischargeable level, the charging apparatus 1 operates the voltage-increasing converter 12 to increase the output voltage of the auxiliary battery BL and charges the main battery BH with the increased voltage.

When an ignition switch (not shown) is turned on, the switch SMR1 and the switch SMR2 are turned on and the main battery BH is coupled to the power control unit PCU. With this, the vehicle becomes in a starting state.

After the operation of the vehicle is started, the voltage-reducing converter 13 reduces the output voltage of the main battery BH and charges the auxiliary battery BL with the reduced voltage.

Next, advantageous effects will be described.

In the embodiment described above, the charging apparatus 1 includes the control circuit 14. The control circuit 14 couples the input terminals of the voltage-increasing converter 12 to the solar panel 10 or the auxiliary battery BL, and couples the output terminals of the voltage-increasing converter 12 to the main battery BH. Also, the control circuit 14 controls the voltage-reducing converter 11 and the voltage-increasing converter 12.

Namely, the input terminals of the voltage-increasing converter 12 can be coupled to the solar panel 10 or the auxiliary battery BL by the control circuit 14. Also, the output terminals of the voltage-increasing converter 12 can be coupled to the main battery BH by the control circuit 14. Therefore, the output voltage of the auxiliary battery BL can be increased by the existing voltage-increasing converter 12 and the main battery BH can be charged with the increased voltage. Accordingly, the output voltage of the auxiliary battery BL can be increased and the main battery BH can be charged with the increased voltage of the auxiliary battery BL, without making the structure of the charging apparatus 1 complex.

When the output power of the solar panel 10 is small, it is difficult to charge the main battery BH with the output voltage of the solar panel 10 even if the output voltage of the solar panel 10 is increased.

In the embodiment described above, when the output power of the solar panel 10 is greater than the first reference power Pref₁₃ H, the control circuit 14 couples the input terminals of the voltage-increasing converter 12 to the solar panel 10 and the output terminals of the voltage-increasing converter 12 to the main battery BH, and controls the voltage-increasing converter 12 so that the output voltage of the solar panel 10 is increased and the main battery BH is charged with the increased voltage. As such, the main battery BH can be properly charged by increasing the output voltage of the solar panel 10.

When the output power of the solar panel 10 is small, it is difficult to charge the main battery BH even if the output voltage of the solar panel 10 is increased. However, the auxiliary battery BL can be charged if the output voltage of the solar panel 10 is reduced.

In the embodiment described above, when the output power of the solar panel 10 is equal to or lower than the first reference power Pref_H and greater than the second reference power Pref_L, the control circuit 14 controls the voltage-reducing converter 11 so that the output voltage of the solar panel 10 is reduced and the auxiliary battery BL is charged with the reduced voltage. Accordingly, the auxiliary battery BL can be properly charged by reducing the output voltage of the solar panel 10.

Even when the output power of the solar panel 10 is small, if the auxiliary battery BL is sufficiently charged, it is possible to increase the output voltage of the auxiliary battery BL and to charge the main battery BH with the increased voltage.

In the embodiment described above, when the output power of the solar panel 10 is equal to or lower than the first reference power Pref_H and the remaining capacity of the auxiliary battery BL is at the dischargeable level, the control circuit 14 couples the input terminals of the voltage-increasing converter 12 to the auxiliary battery BL and couples the output terminals of the voltage-increasing converter 12 to the main battery BH. Also, the control circuit 14 controls the voltage-increasing converter 12 so that the voltage-increasing converter 12 increases the output voltage of the auxiliary battery BL and charges the main battery BH with the increased voltage. Accordingly, the main battery BH can be properly charged by increasing the output voltage of the auxiliary battery BL.

In the embodiment described above, the first reference power Pref H is set to the value that is greater than the power loss that occurs when the main battery BH is charged through the voltage-increasing converter 12. Therefore, the main battery BH can be further properly charged by increasing the output voltage of the solar panel 10.

Further, the first reference power Pref_H is set to the level so that the frequency of charging the main battery BH through the voltage-increasing converter 12 does not exceed the predetermined level. Therefore, the power loss that occurs when the main battery BH is charged through the voltage-increasing converter 12 will be reduced.

In the embodiment described above, the second reference power Pref_L is set to the value that is greater than the power loss that occurs when the auxiliary battery BL is charged through the voltage-reducing converter 11. Therefore, the auxiliary battery BL can be further properly charged by reducing the output voltage of the solar panel 10.

Further, the second reference power Pref_L is set to the level so that the frequency of charging the auxiliary battery BL through the voltage-reducing converter 11 does not exceed the predetermined value. Therefore, the power loss that occurs when the auxiliary battery BL is charged through the voltage-reducing converter 11 will be reduced.

In the embodiment described above, the dischargeable level is any level between the upper limit and the lower limit of the remaining capacity of the auxiliary battery BL. Therefore, the main battery BH can be further properly charged by increasing the output voltage of the auxiliary battery BL.

In the embodiment described above, the output voltage of the solar panel 10 is increased or reduced to charge the main battery BH and the auxiliary battery BL. However, the power generation device is not limited to the solar panel 10. The power generation device may be any other device. In the embodiment described above, the voltage of the solar panel 10 is greater than the voltage of the auxiliary battery BL and lower than the main battery BH, and the auxiliary battery BL is charged after reducing the output voltage of the solar panel 10 by the voltage-reducing converter 11. However, the configuration is not limited to the example described above. The voltage of the solar panel 10 may be lower than the voltage of the main battery BH and the voltage of the auxiliary battery BL. In this case, the voltage-reducing converter 11 shown in FIG. 1 may be changed with a voltage-increasing converter as the first charging circuit. Therefore, the output voltage of the solar panel 10 is increased and the auxiliary battery BL is charged with the increased voltage. Also in this case, the similar advantageous effects will be achieved.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A charging apparatus comprising:
a power generation device;
a first charging circuit having an input terminal coupled to the power generation device and an output terminal coupled to a low-voltage battery, the first charging circuit increasing or reducing an output voltage of the power generation device and charging the low-voltage battery;
a second charging circuit having an input terminal and an output terminal that is coupled to a high-voltage battery having a voltage higher than the low-voltage battery, the second charging circuit increasing a voltage inputted from the input terminal of the second charging circuit and charging the high-voltage battery; and
a control circuit being configured to couple the input terminal of the second charging circuit to one of the power generation device and the low-voltage battery, and to control the first charging circuit and the second charging circuit.

2. The charging apparatus according to claim 1, wherein
the control circuit is configured to couple the input terminal of the second charging circuit to the power generation device and to control the second charging circuit to increase the output voltage of the power generation device and charge the high-voltage battery, when an output power of the power generation device is greater than a first reference power.

3. The charging apparatus according to claim 1, wherein
the control circuit is configured to couple the input terminal of the second charging circuit to the low-voltage battery and to control the second charging circuit to increase an output voltage of the low-voltage battery and charge the high-voltage battery, when an output power of the power generation device is equal to or lower than a first reference power and a remaining capacity of the low-voltage battery is at a dischargeable level.

4. The charging apparatus according to claim 3, wherein
the control circuit is configured to control the first charging circuit to reduce the output voltage of the power generation device and charge the low-voltage battery, when the output power of the power generation device is equal to or lower than the first reference power and greater than a second reference power that is lower than the first reference power.

5. The charging apparatus according to claim 2, wherein
the first reference power is set to a value greater than power loss that occurs when the high-voltage battery is charged through the second charging circuit.

6. The charging apparatus according to claim 5, wherein
the first reference power is set so that a frequency of charging the high-voltage battery through the second charging circuit is equal to or lower than a predetermined value.

7. The charging apparatus according to claim 4, wherein
the second reference power is set to a value greater than power loss that occurs when the low-voltage battery is charged through the first charging circuit.

8. The charging apparatus according to claim 7, wherein
the second reference power is set so that a frequency of charging the low-voltage battery through the first charging circuit is equal to or less than a predetermined value.

9. The charging apparatus according to claim 3, wherein
the dischargeable level is a level between an upper limit and a lower limit of the remaining capacity of the low-voltage battery.

10. The charging apparatus according to claim 1, wherein
the power generation device is a solar panel that generates electric power from a solar light.
